(19) United States
(12) Patent Application Publication
(10) Pub. No.: US 2025/0344057 A1
(43) Pub. Date: Nov. 6, 2025

(54) METHODS AND APPARATUS FOR DISTRIBUTED CONTROL PLANE ARCHITECTURE AND SECURITY

(71) Applicant: InterDigital Patent Holdings, Inc., Wilmington, DE (US)

(72) Inventors: Samir FERDI, Kirkland (CA); Ulises OLVERA-HERNANDEZ, Saint-Lazare (CA); Saad AHMAD, Montreal (CA); Rocco DI GIROLAMO, Laval (CA); Zhibi WANG, Woodridge, IL (US); Michelle PERRAS, Montreal (CA)

(73) Assignee: InterDigital Patent Holdings, Inc., Wilmington, DE (US)

(21) Appl. No.: 18/654,426

(22) Filed: May 3, 2024

(51) Int. Cl. H04W 12/033; H04W 12/0431; H04W 12/062

(52) U.S. Cl. CPC H04W 12/033; H04W 12/0431; H04W 12/062

(57) ABSTRACT

Methods and apparatus are described. A method, implemented in a base station, includes transmitting information in a system information block (SIB). The information includes an indication that the base station is configured to operate as a service based interface (SBI) gateway between one or more wireless transmit/receive units (WTRUs) and an SBI capable core network. The base station receives, from a WTRU of the one or more WTRUs, a first radio resource control (RRC) message. The first RRC message includes an end-to-end SBI registration request message for the SBI capable core network. The base station send a first SBI message, to an authentication and authorization function (AAF) of the SBI capable core network. The first SBI message includes the end-to-end SBI registration request message and an indication of a type of authentication and authorization requested.

### SUMMARY

Methods and apparatus are described. A method, implemented in a base station, includes transmitting information in a system information block (SIB). The information includes an indication that the base station is configured to operate as a service based interface (SBI) gateway between one or more wireless transmit/receive units (WTRUs) and an SBI capable core network. The base station receives, from a WTRU of the one or more WTRUs, a first radio resource control (RRC) message. The first RRC message includes an end-to-end SBI registration request message for the SBI capable core network. The base station send a first SBI message, to an authentication and authorization function (AAF) of the SBI capable core network. The first SBI message includes the end-to-end SBI registration request message and an indication of a type of authentication and authorization requested.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of a simplified version of a 5G service based architecture (SBA);

FIG. 3 is a block diagram of the control plane stack between the WTRU and the AMF;

FIG. 4 is a diagram showing key hierarchy generation in 5G;

FIG. 5 is a block diagram of an example network architecture with the RAN acting as the SBI gateway;

FIG. 6 is a signal diagram of an example of WTRU initial registration using a RAN node as the SBI gateway, which may be implemented using the network architecture of FIG. 5;

FIG. 7 is a flow diagram of an example method of initial registration implemented in a base station in a distributed control plane architecture;

FIG. 8 is a signal diagram of an example of WTRU PDU session establishment using a RAN node as an SBI gateway in a system implementing the architecture illustrated, for example, in FIG. 5 and described above;

FIG. 9 is a flow diagram 900 of an example method of PDU session establishment implemented in a base station in a distributed control plane architecture;

FIG. 10 is a block diagram of the control plane stack between the WTRU and the CN with the RAN node acting as the SBI gateway; and

FIG. 11 is a diagram showing an example next generation control plane protocol stack (e.g., RRC or PDCP) between the RAN and the CN with an SBI capable RAN.

### DETAILED DESCRIPTION

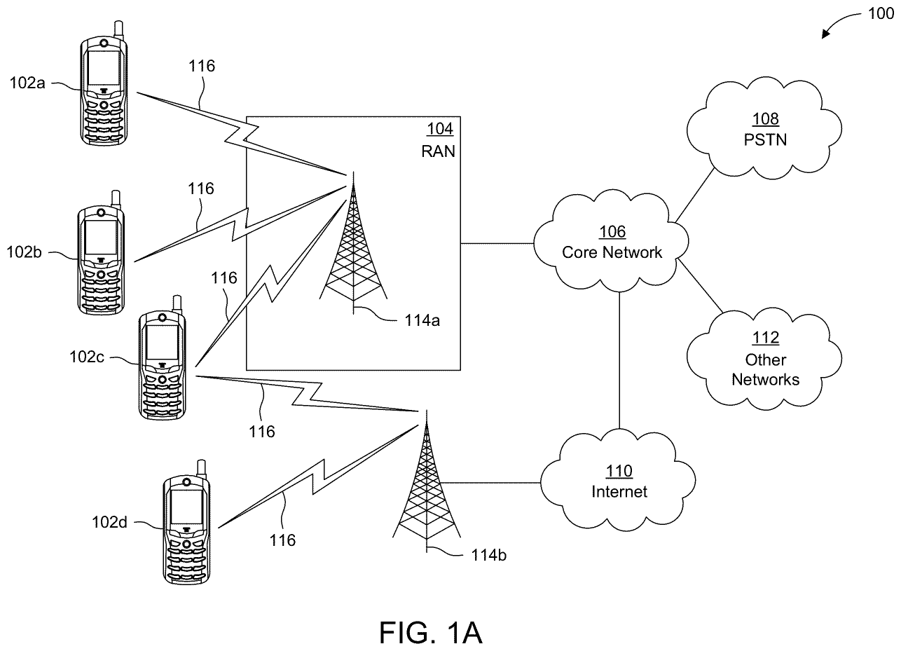

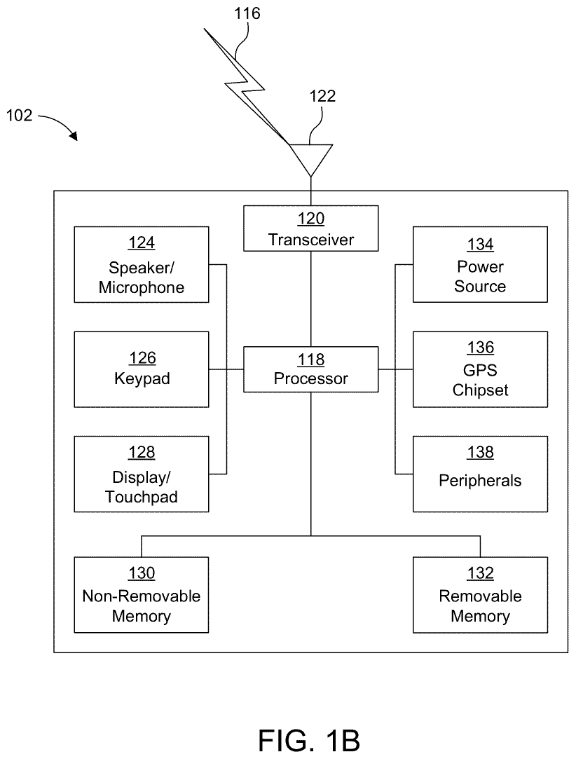

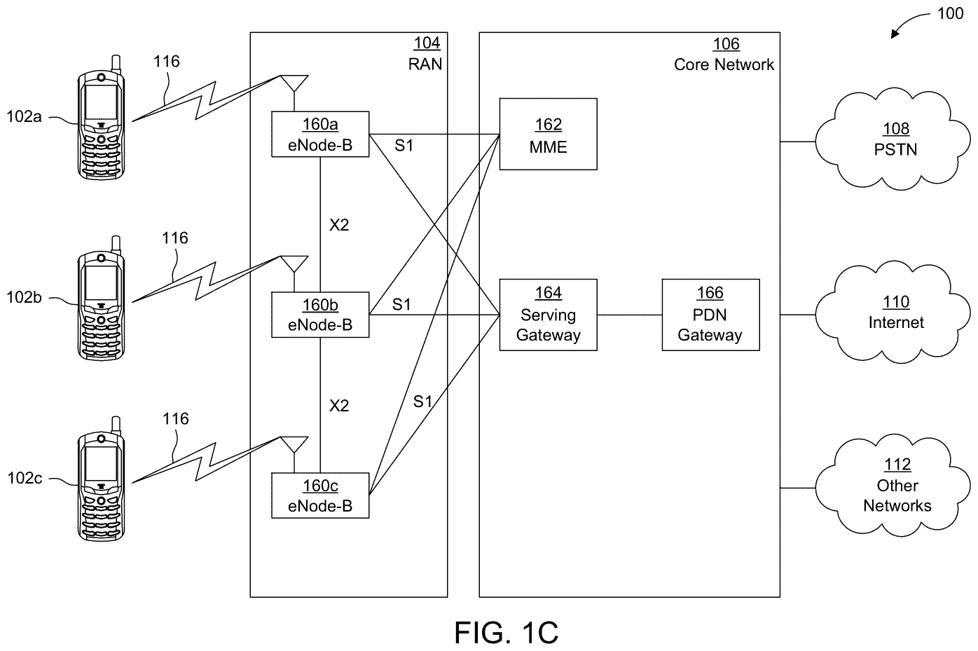

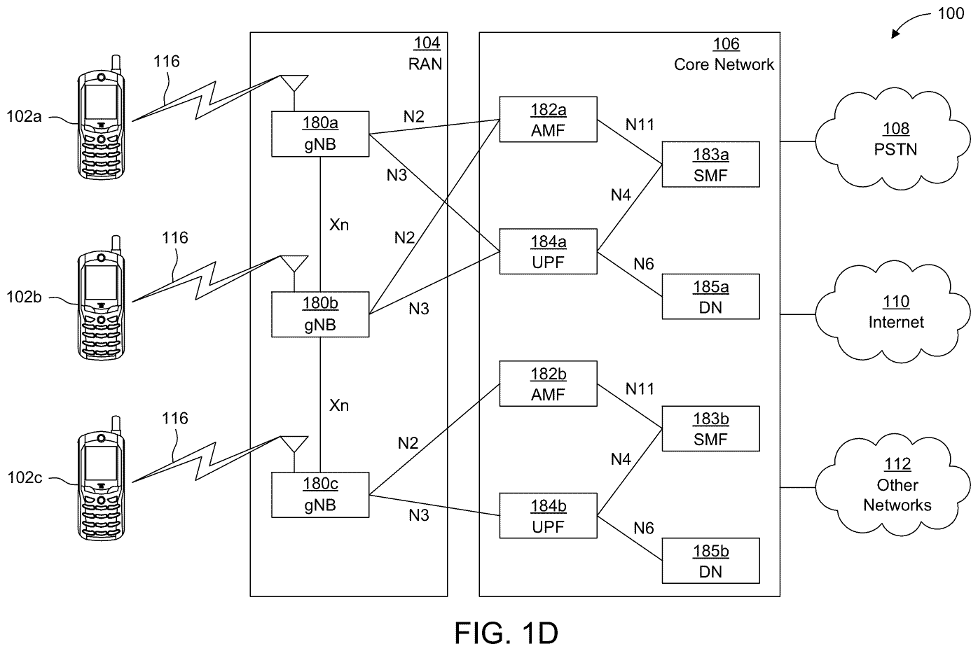

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

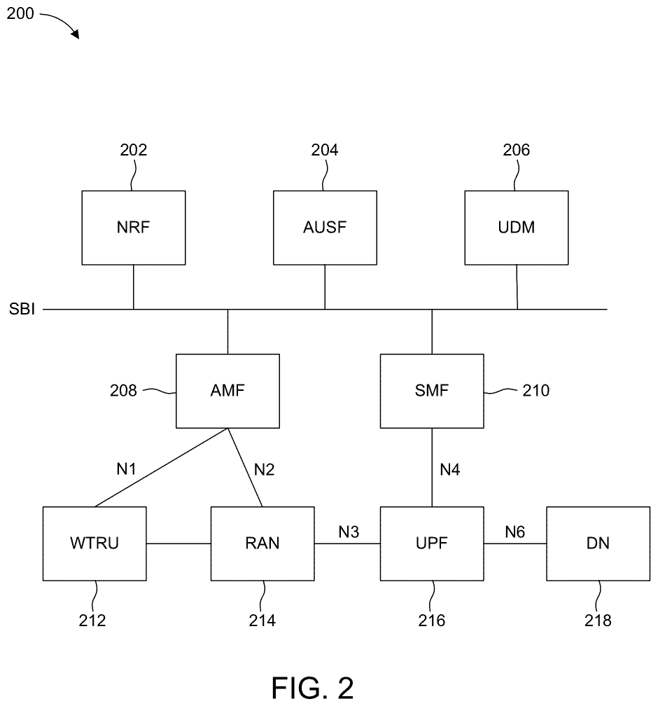

FIG. 2 is a block diagram 200 of a simplified version of a 5G service based architecture (SBA). A goal of the SBA is to enable network functions (NFs) to expose services, such as using RESTful application programming interfaces (APIs), so that the system can provide the desired functionality. In the example illustrated in FIG. 2, only a subset of the NFs are represented. More specifically, in the example illustrated in FIG. 2, the network repository function (NRF) 202, authentication server function (AUSF) 204, the unified data management (UDM) function 206, the access and mobility management function (AMF) 208, and the session management function (SMF) 210 are represented. The NFs may communicate with each other using a service based interface (SBI) using protocols such as hypertext transfer protocol (HTTP), as shown in FIG. 2.

The other interfaces illustrated in FIG. 2, namely N1, N2 and N4 are different from SBI. In the example illustrated in FIG. 2, a WTRU 212 may communicate with the AMF 208 over the N1 interface using the NAS protocol. The WTRU 212 may perform control plane messaging with other NFs, such as the SMF 210, using a transport encapsulation mechanism provided by the AMF for the NFs. The UPF 216 may communicate with the SMF 210 using the N4 interface and may communicate with the data network (DN) using the N6 interface. The RAN 214 may communicate with the UPF using the N3 interface and may communicate with the AMF 208 using the N2 interface.

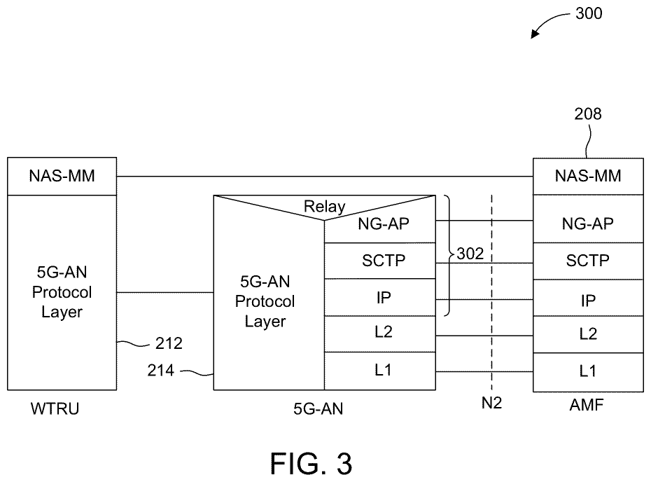

FIG. 3 is a block diagram 300 of the control plane stack between the WTRU 212 and the AMF 208. In the example illustrated in FIG. 3, the RAN 214 communicate with the AMF 208 over the N2 interface using a next generation application protocol (NGAP), while the WTRU 212 and the AMF 208 may communicate with each other, directly, using the N1 interface, as described above. Control plane messages between the WTRU 212 and the RAN 214 access stratum (AS) may be performed using radio resource control (RRC) 302, which may be used to transport NAS messages received or sent by the RAN over the N2 interface.

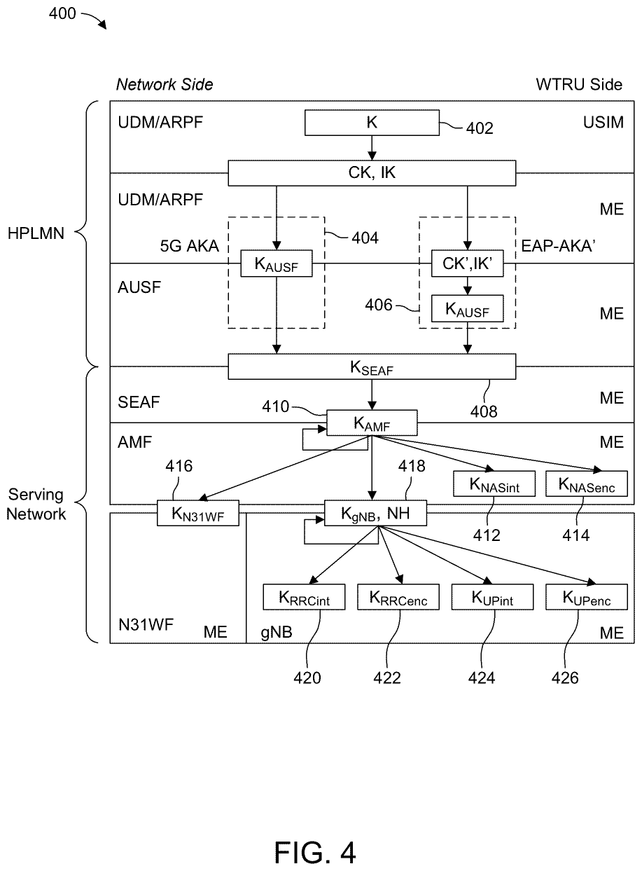

FIG. 4 is a diagram 400 showing key hierarchy generation in 5G. In the example illustrated in FIG. 4, the WTRU the serving network pre-share a key K (402), which may be used to derive all session keys, as shown in FIG. 4. 5G defines two mandatory primary authentication methods, EAP-AKA' 406 and 5G AKA 404 for the WTRU and the serving network. These methods are based on the extensible authentication protocol (EAP) framework in which the WTRU plays the role of the peer, the security anchor function (SEAF) plays the role of the authenticator, and the AUSF plays the role of the authentication server. Following successful primary authentication 404, 406, the SEAF, which may be co-located with the AMF, may obtain a WTRU permanent ID (SUPI) and the anchor key (K_{SEAF} 408) from the AUSF, which may be used to derive the K_{AMF} 410 security context and the AS security context K_{gNB} 418 on both the WTRU and network sides. The K_{AMF} 410 may be used to derive the confidentiality key K_{NASint} 412 and the integrity key K_{NASenc} 414 for NAS signaling. The K_{AMF} 410 may also be used to derive the key K_{N3IWF} 416. The WTRU and corresponding gNB may use the security context K_{gNB} 418 to derive the confidentiality signaling key K_{UPint} 424 and the integrity signaling key K_{UPenc} 426 for the user plane as well as the confidentiality signaling key K_{RRCint} and the integrity signaling key K_{RRCenc} for the control plane to protect traffic therebetween.

The Next Generation Network architecture is expected to continue and further push the shift started in 5G to embracing a cloud native implementation in the Core Network (CN). The push to bring the CN user plane and other functions closer to the edge will continue to be motivated by the need to support ever increasing traffic levels and lower latencies (e.g., extended reality (XR), Metaverse, Artificial Intelligence/Machine Learning (AIML)). With this major trend, the possibility to extend SBA to the RAN emerges to simplify the network architecture while taking advantage of cloud native and micro-services architecture capabilities (e.g., scalability, elasticity, open interfaces). For example, new architecture proposals are emerging with the possibility to extend the SBI framework beyond the 5GC NFs, such as illustrated in shown in FIG. 2. For example, a WTRU may use an evolved NAS mechanism to exchange NAS messages directly with one or more NFs. As an example, an SBI compliant WTRU may establish an application layer communication directly with an NF (e.g., SMF) without going through the AMF (i.e., instead of via the N1 interface).

In another trend, the next generation network is touted as bringing about so called connected intelligence where intelligent networks using AIML technology may be able to connect a multitude of intelligent things. With a large amount of data collection from a multitude of devices (e.g., sensors, Ambient IoT) and with the added high flexibility and adaptability of AIML enabled functionalities, the system will pave the way for new advanced applications, such as XR/Metaverse.

The AMF is responsible for several functionalities that are tightly integrated together. Some of these functionalities include WTRU registration/mobility management, authentication and authorization, security, network slice access control, WTRU context management, and NAS transport. Such bundling of functionality together is more representative of a monolithic application approach than the microservices architecture embraced (or at least envisioned) with the adoption of the SBA. The drawbacks associated with monolithic architectures are well documented, and, in the 5GC case, this translates into inability to fully scale independently the functions that are part of the AMF. For example, the mobility/connection management function in the AMF typically needs to handle a much higher number of WTRU requests than the authentication function due to the number of connected/mobile WTRUs versus WTRUs requesting initial access. An overload at the AMF, due to mobility management and other signaling events, may hinder AMF availability to provide timely access (e.g., authenticate) to new WTRUs.

The AMF acts as a single NAS termination point for WTRU communications with the 5GC, including when the WTRU wishes to communicate with other NFs. This tight coupling between the various NFs and the AMF may prevent independent scaling of the various services offered by the network (e.g., AMF versus other NFs). For example, a WTRU may be delayed or prevented from accessing a network slice if the AMF is experiencing a congestion condition, even if the other relevant resources (e.g., SMF, UPF) are available.

The NGAP interface between the RAN and the AMF uses a connection-oriented transport protocol (SCTP). This requires the maintenance of a stateful connection between the AMF and the RAN, which involves, for instance, the binding or unbinding of each WTRU information while the WTRU connects or disconnects to the RAN. Furthermore, if the WTRU connects via a gNB that is connected to a different AMF (target AMF) than its last serving AMF (source AMF), a transfer of WTRU context needs to be performed from the source to the target AMF. The transfer may involve regenerating a new security context for the target AMF (RAN and WTRU) if a horizontal key derivation is performed. This creates additional signaling and computing overhead in the system.

The AN protocol stack between the WTRU and the RAN, and namely the top transport and security layers (RRC, PDCP), have been reused with incremental changes since 3G. The existing install base of billions of devices (terminal and base stations) that are using these protocols attests to the proven maturity and robustness of these protocols. Considering the level of existing investments, the next generation network should aim to reuse as much of the current generation air interface, transport and security as possible while still evolving to satisfy new requirements and address potential gaps.

Accordingly, for the next generation system control plane, it may be desirable to enhance the CN architecture to improve the modularity, scalability, and flexibility such that, for example, it is better aligned with micro-services architecture principles. It may also be desirable to enhance the system towards a better harmonization between the RAN and the CN by, for example, avoiding the tight coupling using closed interfaces and redundancies. Additionally, it may be desirable to ensure all of this while minimizing the impact or reusing as much of the current generation air interface transport protocols as possible.

Methods and apparatus are described herein where a Next Generation RAN node, or intelligent Node B (iNB), may act as an SBI gateway between a WTRU and a Next Generation Core Network (nCN). The core network architecture described herein also evolves the 5GC architecture by disaggregating some existing more monolithic functions (e.g., AMF) into more micro-service friendly dedicated functionalities. These new NFs may provide functionality related to authentication/authorization, WTRU context management, registration and mobility management. Embodiments described herein may allow the iNB to directly invoke the appropriate SBI service and/or invoke the appropriate SBI service on behalf of the WTRU using the new NFs or NFs evolved from existing ones (e.g., SMF). Therefore, the embodiment described herein may provide the operator with means to support a more flexible way to independently scale functions and remove the tight coupling and functional bottleneck that exists between the AMF and gNB. The end-to-end SBI mechanism between the WTRU and the Next Generation Core Network described herein may be called a distributed NAS mechanism (as opposed to the current point-to-point NAS between the WTRU and AMF). This distributed NAS mechanism may allow direct messaging between the WTRU and any NF in the Core Network. The iNB acting as a distributed NAS anchor point may provide the AS layer transport for the distributed NAS messaging.

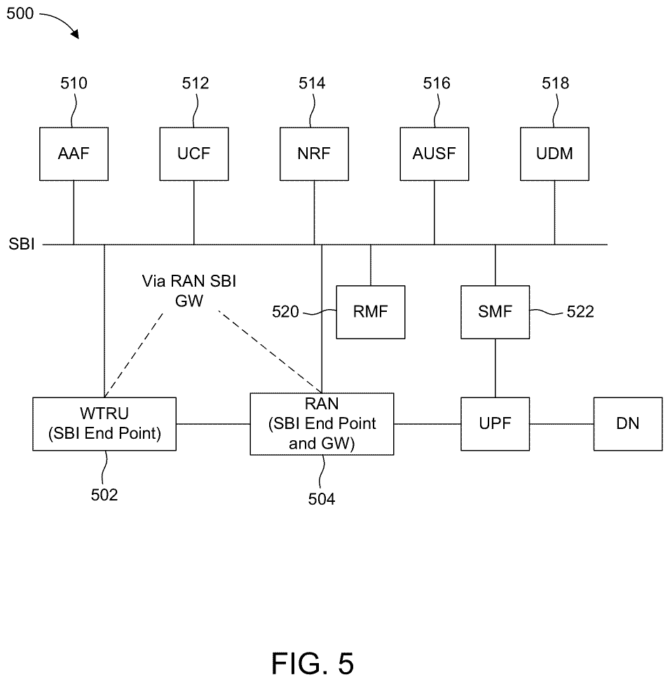

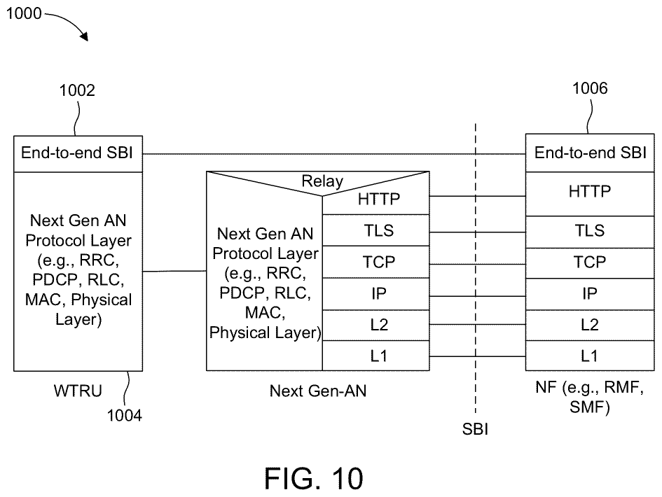

FIG. 5 is a block diagram of an example network architecture 500 with the RAN 504 acting as the SBI gateway. In the example illustrated in FIG. 5, the RAN node 504, which may also be referred to herein as a base station or intelligent NodeB (iNB), supports SBI toward the next generation core network (also referred to as nCN herein). The WTRU 502 and RAN node 504 support transport of SBI messages over the air. The protocol stack between the WTRU and nCN and RAN Node is described below with respect to FIG. 10. The RAN node 504 may directly invoke needed services according to a procedure performed with the WTRU 502.

For example, the RAN node 504 may first invoke the authentication and authorization service (AAF) 510 when a WTRU, such as the WTRU 502 illustrated in FIG. 5, requests initial access. The AAF 510 may act as a generic authenticator (e.g., in an EAP framework) that may provide different types of authentications (e.g., primary or secondary authentication) towards different authentication servers (e.g., the AUSF 516 or a third party AAA). The AAF 510 may be invoked and reused in different procedures by different NFs, for example in a primary authentication (e.g., by the RAN node 504), in a PDU Session secondary authentication (e.g., by the SMF 522), in a slice, or in a user identity specific authentication (e.g., by the Registration and Mobility Management Function (RMF) 520).

Once the WTRU 502 is successfully identified and authenticated, the RAN node 504 can invoke the services of a UE Context management function (UCF) 512. The UCF 512 may act as a representative of the WTRU in the nCN. As such, it may maintain stateful information related to the WTRU, such as registration/connection states, location, security context (the key material for SBI level security and AS security), subscription data from the UDM 518, or session management information (e.g., PDU session contexts). In other words, the UCF 512 may provide a WTRU context as a service to other NFs in the nCN. Unlike the WTRU context in AMF, the UCF maintains and centralizes all information related to the WTRU to allow operations from other NFs and/or services to remain as stateless as possible for better scalability and simplicity. As the holder of security keys (nCN security association with the WTRU), the UCF also provides a WTRU security as a service, which may include key distribution service to the RAN for AS security establishment and end-to-end SBI message security processing (between the WTRU and the nCN), such that the NFs may invoke the UCF to process (respectively protect) end-to-end SBI messages received (respectively sent) to the WTRU.

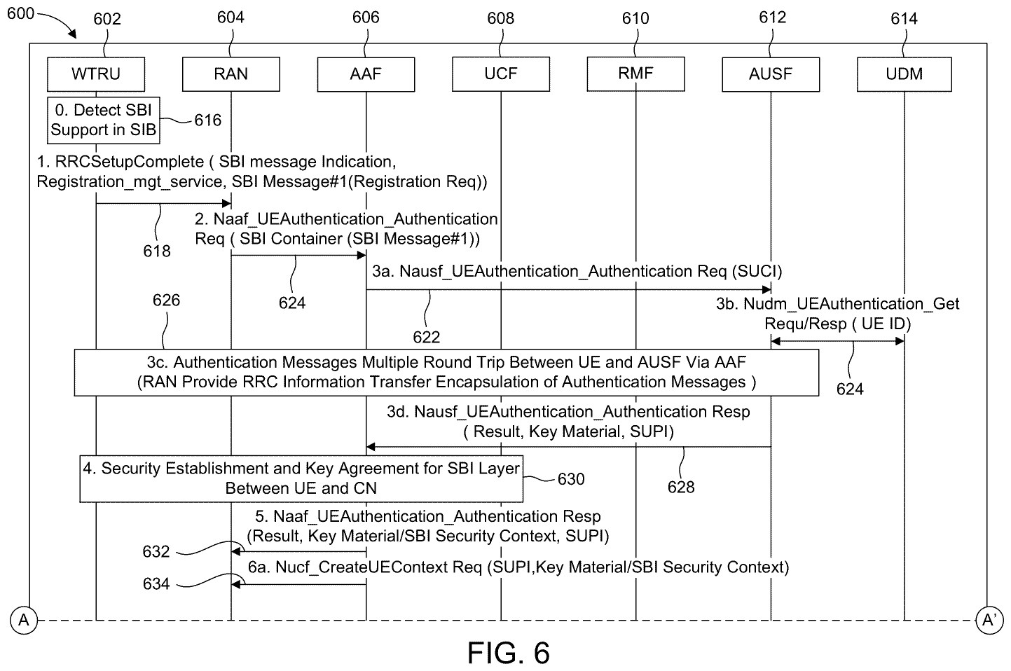

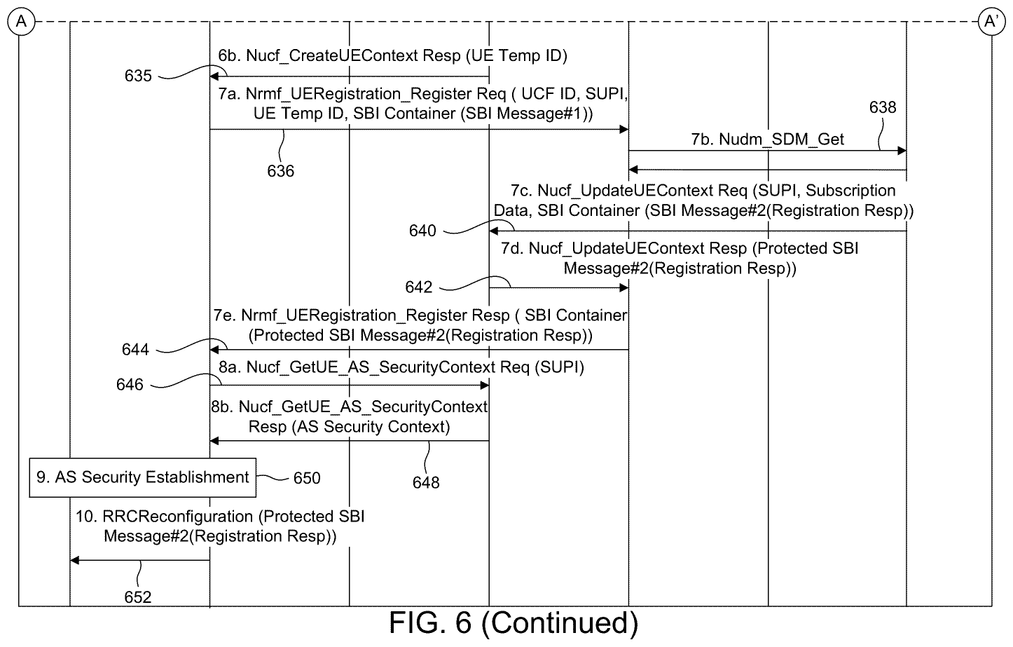

The RAN node 504 may invoke the services of the RMF 520 for access control or mobility updates of the WTRU 502. The RMF 520 may rely on another NF, the UCF 512, for stateful information maintenance. No tightly coupled connection may exist between the RAN node 504 and the RMF 520 (unlike a gNB with an AMF). Therefore, any available RMF instance may be selected (e.g., following discovery using an NRF 514) and invoked by the RAN node 504 to handle WTRU access control or mobility update logic. The RMF 520 is one of the components of the disaggregated functionality that stems from the conventional AMF. As such, it is responsible for a subset of the functionality of an AMF (e.g., registration, network or slice access control) with new types of interactions with the RAN node and new interactions with the UCF 512, as described in more detail below with respect to FIG. 6. As other functions, such as the AAF 510, the RMF 520 may process an end-to-end SBI message from the WTRU forwarded by the RAN node 504. The RMF 520 may be a stateless function (unlike the AMF) that does not maintain a WTRU state (e.g., registration or connection state) and may be loosely coupled with the RAN using SBI based interactions (e.g., instead of a persistent SCTP connection). The RMF 520 may interact with the service provided by the UCF 512 for WTRU context management. As such, any available RMF can be selected by the RAN node 504 (e.g., based on load level) for handling initial and subsequent mobility and registration updates messages from the WTRU 502, which may also eliminate to the need to transfer contexts between NFs (as can be the case with AMFs).

The RAN node 504 may invoke the SMF 522 for session management service. The SMF 522 may be an evolved version of the 5G SMF to support direct interaction with the RAN node 504 for actions such as user plane resource allocation and/or AN-CN tunnel establishment. Direct communication between the RAN node 504 and the SMF 522 may allow for a reduction of SBI overhead due to messaging with intermediate NF (e.g., AMF) compared to 5G. This may also allow for the RAN node 504 to provide access to network resources (e.g., slice, PDU Session) without the issue of potential congestion at the AMF preventing such access in the case of 5G. Furthermore, the SMF 522 (or other functions such as the NEF) using the evolved SBI, may enable the transport of small data over the SBI. For example, the small data carried in an SBI message container may be sent to an nCN SBI endpoint (e.g., to an internal UPF within the SMF itself or a NEF) that then forwards the data to its destination.

FIG. 6 is a signal diagram of an example of WTRU initial registration using a RAN node as the SBI gateway, which may be implemented using the network architecture of FIG. 5. In the example illustrated in FIG. 6, a WTRU 602 may determine that a RAN node 604 supports SBI based on receiving an indication of support for SBI in the SIB broadcast by the RAN node 604 (602). The WTRU 602 may also initiate RRC connection setup (e.g., Random access, RRCSetupRequest, RRCSetup).

The WTRU 602 may construct an end-to-end SBI message for registration (e.g., a Registration Request message). The message may include a WTRU identity (e.g., SUCI) and other parameters such as WTRU capabilities, network slices, and power saving parameters. The message may comply with an SBI compliant representation (e.g., JSON). The WTRU 602 may send to the RAN node 604 an RRC message including an indication of the SBI message, a registration management service indication, an initial registration request indication, and a first SBI message (SBI message #1) (618).

The RAN node 604 may determine which of the one or more services of the nCN to invoke and to forward SBI message #1 to, in order the achieve the desired functionality (e.g., authentication and authorization, access control, registration of the WTRU). SBI message #1 is an end-to-end message between the WTRU 602 and the nCN, which means it remains opaque to (i.e., content not processed by) the RAN node 604, which transparently forwards it to the nCN relevant NFs. The RAN node 604 may detect the presence of an end-to-end SBI message based on the indication of the SBI message received in the RRC message from the WTRU 602. The indication may be used to determine whether the WTRU supports interfacing with nCN, as described in more detail below. The indication may also indicate a protection level for the included end-to-end SBI message, as described in more detail below.

The RAN node 604 may determine that authentication of the WTRU is required and may invoke the services of an Authentication and Authorization Function (AAF) 606 based on the initial registration request indication and/or lack of reference to a valid WTRU context in the RRC message. The RAN node 604 may discover the AAF 606 using an NRF. The RAN node 604 may send an authentication request message (626) to the AAF 606 including SBI message #1. The authentication request may indicate the type of authentication invoked. The type of authentication that can be supported by the AAF 606 in an authentication request message can be any of a primary authentication of a WTRU, user identity based authentication, slice specific authentication, or secondary authentication.

For initial authentication, the AAF 606 may initiate an authentication procedure (622, 624, 626, 628) between the AUSF 612 and the WTRU 602 (e.g., based on 5G AKA or EAP AKA') based on authentication vector from the AUSF 612 obtained from UDM 614 in message 624. Multiple messages may be exchanged between the AUSF 612 and the WTRU 602 via the AAF 606 and the RAN node 604. For example, the AAF 606 may send to the RAN node 604 an authentication message including an end-to-end SBI message (e.g., Authentication Request). The RAN node 604 may transfer the end-to-end SBI message to the WTRU in an RRC message including an SBI message indication and authentication management service indication. The SBI message indication may indicate to the RAN node 604 the presence of a DL end-to-end SBI message to be forwarded the WTRU 602. The WTRU 602 may determine the presence of an end-to-end SBI message from the authentication message service based on the two indications. The end-to-end SBI message may, for example, include an identity request or an authentication challenge.

The WTRU 602 may send to RAN node 604 an RRC message including an indication of an SBI message, an authentication management service indication, and an end-to-end SBI message (e.g., Authentication Response). The RAN node 604 may forward the end-to-end SBI message to the AAF 606. The AAF 606 may verify the WTRU response with the AUSF 612. The AAF 606 may send an authentication message to the RAN node 604 including an end-to-end SBI message (e.g., Authentication Result). The RAN node 604 may transfer the end-to-end SBI message to the WTRU 602 in an RRC message including an SBI message indication and authentication management service indication.

Upon successful authentication message 628, an SBI access key (K_{SBI}) may be derived by the WTRU 602 and the AAF 606. Unlike the K_{AMF}, which establishes a point-to-point security association between the WTRU and an AMF, the K_{SBI} may be used to create a shared security association between the WTRU 602 and the nCN such that any NF may invoke the services of a UCF 608 to process the security or protect end-to-end SBI messages between the NF and the WTRU as described below. Upon successful authentication, the AAF 606 may initiate a security procedure (e.g., key agreement) to establish the security context for the end-to-end SBI communication security between the WTRU 602 and the nCN.

At 630, the AAF 606 may send a security establishment message to the RAN node 604 including an end-to-end SBI message (e.g., Security Mode Command). The RAN node 604 may transfer the end-to-end SBI message to the WTRU 602 in an RRC message including an SBI message indication and security management service indication. The end-to-end SBI message may be integrity protected using a key derived from K_{SBI}(K_{SBIint}). The WTRU 602 may verify that end-to-end SBI message integrity is protected using a key derived from K_{SBI}(K_{SBIint}). The WTRU 602 may send an RRC message to the RAN node 604 including an indication of an SBI message, a security management service indication, and an end-to-end SBI message (e.g., Security Mode Command Complete). The end-to-end SBI message may be confidentiality protected using a K_{SBIenc} derived from K_{SBI}, and integrity may be protected using K_{SBIint}. The RAN node 604 may forward the end-to-end SBI message to the AAF 606. The AAF 606 may verify the WTRU end-to-end SBI message security using K_{SBIenc} and K_{SBIint}.

The RAN node 604 may receive an Authentication response message (632) from the AAF 606, which may include a WTRU ID (e.g., SUPI) and security context (e.g., K_{SBI}, K_{SBIenc}, K_{SBIint}) confirming the successful WTRU authentication.

The RAN node 604 may locate a UCF 608 using NRF. The RAN node 604 may request the services of the UCF 608 (634) to create a new WTRU context providing the WTRU ID and security context. The UCF 608 may store the context and allocate a unique WTRU temporary ID (WTRU temp ID) mapped to the WTRU context/WTRU ID (635). Alternatively, the AAF 606 may request the WTRU context creation and storage of security context from the UCF in 632. In that case, the AAF 606 may send the UCF ID and WTRU ID to the RAN node 604.

The RAN node 604 may locate an RMF 610 using NRF and send a Registration request message (636) to the RMF 610 including the UCF ID, the WTRU ID, the WTRU temporary ID and the SBI message #1 from the WTRU 602. The RMF 610 may retrieve WTRU subscription data (638) from the UDM 614 given the WTRU ID. The RMF 610 may process the SBI message #1 and verify WTRU authorization for access using the subscription data and generate an SBI message #2 (e.g., Registration Accept message) including the WTRU temporary ID. The RMF 610 may request the UCF 608 to update the WTRU context (e.g., store subscription data, location such as last known TAI, connection state) (640, 642). The RMF 610 may request the UCF 608 to protect the SBI message #2 (e.g., encrypted, integrity protected using stored K_{SBIenc}, K_{SBIint}). The UCF 608 (or RMF 610) may subscribe to the UDM 614 for subscription data update notifications. The RMF 610 may be bound to the WTRU context by RMF registering its RMF ID in the WTRU context. The RMF 610 may send a Registration response message (644) to the RAN node 604 including the protected SBI message #2.

The RAN node 604 may request (646 an AS session key (K_{iNB}) from the UC 608F providing WTRU ID. The UCF 608 may derive K_{iNB} from K_{SBI} and provide it to the RAN node 604 (648). The RAN node 604 may register with the UCF 608 as the last known serving RAN node 604 and subscribe to UCF 608 for WTRU-related notifications (e.g., implicitly) using the message to request the K_{iNB} or (e.g., explicitly) using a separate message.

The RAN node 604 may perform a conventional AS security establishment procedure (650) with the WTRU 602 to secure RRC messages (e.g., using an AS Security Mode Command procedure). The WTRU 602 and the RAN node 604 may derive encryption and integrity keys (e.g., K_{iNBint}, K_{iNBenc}) based on the K_{iNB}.

The RAN node 604 may send, to the WTRU 602, an RRC message (652), which may include an indication of the SBI message, a registration management service indication, and the protected SBI message #2.

For a registration update, the initial registration procedure as illustrated in FIG. 6 may be used but with some differences. In 618, the WTRU 602 may include a UCF ID, WTRU temporary ID and update request indication (e.g., mobility, periodic) in addition to the above-mentioned parameters. The WTRU 618 may protect the SBI message #1 using the already established SBI security context as described above relative to 630 in FIG. 6. The WTRU 618 may skip protecting the SBI message if it has a valid AS security context shared with the RAN node 604. In that case, the RRC message protection using the AS security context may provide protection for the SBI message. This may allow the WTRU 602 and the network to avoid, for example, redundant encryption of the AS envelope and the embedded end-to-end SBI message. This may be, for example, determined by the WTRU 602 based on an operator option configured in the WTRU 608 by the network to enable energy efficient operations.

If a valid WTRU context is found at the given UCF ID and for the WTRU identified by the WTRU temporary ID, 624, 622, 624, 626, 628, 630, 632, 634 and 635 can be skipped. The RAN node 604 may reject the request if no valid context is found for the given WTRU temporary ID as this may correspond to a misbehaving or malicious WTRU.

At 634, the RAN node 604 may not request the UCF 608 to create a new WTRU context. Instead, the RAN node 604 may verify that there is a valid WTRU context at indicated by UCF given the WTRU temporary ID. The RAN node 604 may obtain a new WTRU temporary ID, the WTRU ID and an RMF ID if there is an RMF bound to the WTRU context. The RAN node 604 may locate an RMF 610 using NRF if no RMF ID is returned by the UCF 608.

At 636, the RAN node 604 may also indicate to the RMF 610 that this is a registration update. The RMF 610 may not retrieve the subscription data from the UDM 614 but from UCF 608.

At 646, the RAN node 604 does not need to request a new K_{iNB} if it already has a valid AS security context for the WTRU 602. In that case, 650 may be skipped.

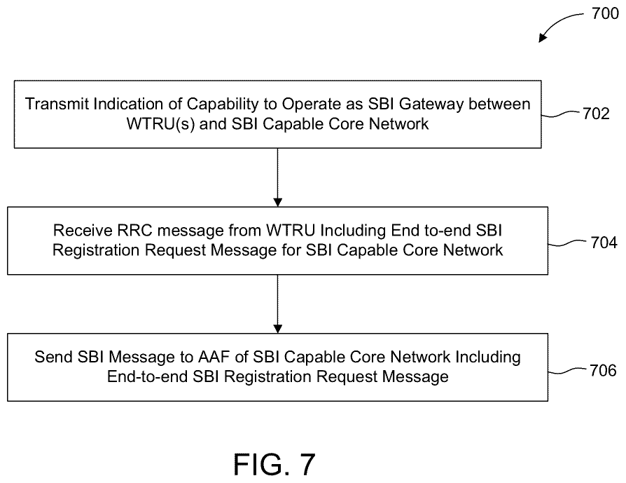

FIG. 7 is a flow diagram 700 of an example method of initial registration implemented in a base station in a distributed control plane architecture. In the example illustrated in FIG. 7, the base station transmits information in a SIB (702). The information may include an indication that the base station is configured to operate as an SBI gateway between one or more WTRUs and an SBI capable core network. The base station may receive, from a WTRU of the one or more WTRUs, a first RRC message (704). The first RRC message includes an end-to-end SBI registration request message for the SBI capable core network. The base station may send a first SBI message to an AAF of the SBI capable core network (706). The first SBI message may include the end-to-end SBI registration request message and an indication of a type of authentication and authorization requested.

The base station may receive a second SBI message, from the AAF. The second SBI message may include an end-to-end SBI authentication request message. The end-to-end SBI authentication message may include one of a request for an identity of the WTRU to be authenticated or a challenge to authentication of the WTRU. The base station may receive, from the AAF, a third SBI message. The third SBI message may include an end-to-end security mode command SBI message intended for the WTRU. The end-to-end security mode command SBI message may be protected using a first security key derived from an SBI access key that was derived by the WTRU and the AAF during authentication. The base station may send the end-to-end security mode command SBI message to the WTRU.

The base station may receive a fourth SBI message from the WTRU. The fourth SBI message may include an end-to-end security mode command complete SBI message. The end-to-end security mode command complete SBI message may be confidentiality protected using a second security key derived from the SBI access key and may be integrity protected using the first security key. The base station may send the end-to-end security mode command complete SBI message to the AAF.

The base station may receive a fifth SBI message form the AAF. The fifth SBI message may include an indication of successful authentication of the WTRU, a WTRU identifier (ID) for the WTRU, and a security context. The security context may include an indication of the first security key, the second security key, and the SBI access key. The base station may send a request to a UCF to create a new WTRU context for the WTRU, store the first security key, the second security key, and the SBI access key in the WTRU context, and receive, from the UCF, a temporary ID for the WTRU. The base station may send a registration request message to an RMF. The registration request message may include the end-to-end SBI registration request message. The base station may receive, from the RMF, a registration response message. The registration response message includes an end-to-end SBI registration accept message that is protected by the UCF. The base station may send a request to the UCF for an AS session key, register with the UCF as a last known serving base station, subscribe to the UCF for WTRU-related notifications, perform security establishment with the WTRU to secure RRC transmissions, and send, to the WTRU, a second RRC message. The second RRC message may include the end-to-end SBI registration accept message.

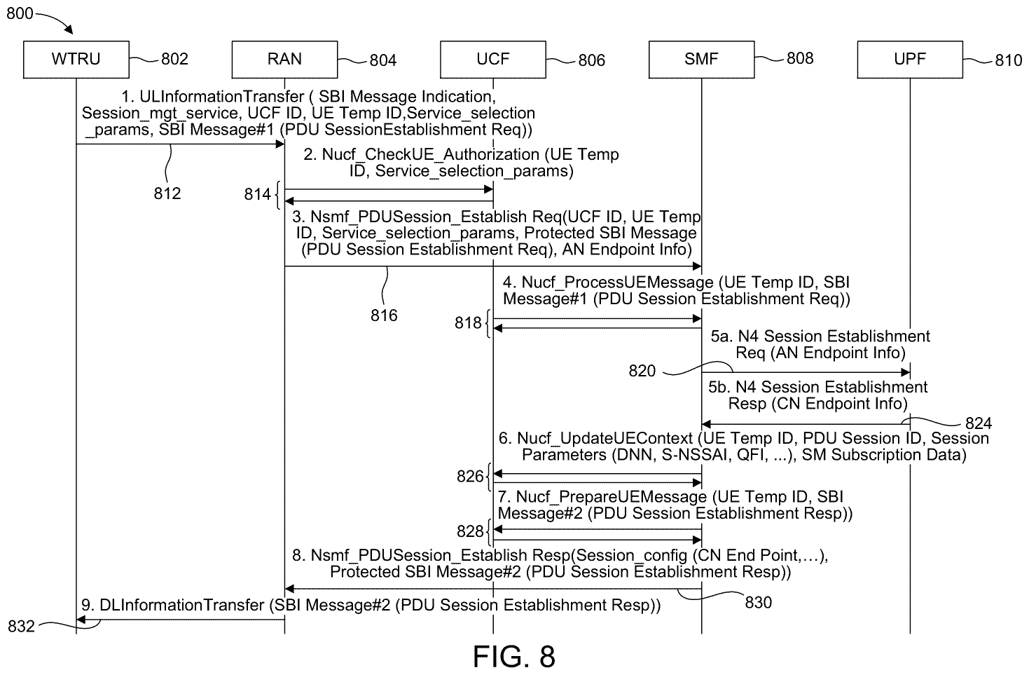

FIG. 8 is a signal diagram of an example of WTRU PDU session establishment using a RAN node as an SBI gateway in a system implementing the architecture illustrated, for example, in FIG. 5 and described above. In the example illustrated in FIG. 8, a WTRU 802 constructs a protected end-to-end SBI message (SBI message #1) for communication session establishment. The SBI message #1 may also be referred to as a PDU Session Establishment Request message herein. The message includes parameters for the session, such as data network, network slice, and/or small data container. The WTRU 802 may send, to a RAN node 804, an RRC message including an indication of the SBI message, a UCF ID, a WTRU temporary ID, session selection parameters (e.g., DNN, S-NSSAI), a session management service indication, initial request indication, and SBI message #1 (812). If the WTRU 802 has a security context with the RAN node 804 (e.g., the RRC message is confidentiality/integrity protected), the WTRU 802 may not need to protect the SBI message #1. The indication of the SBI message may indicate the protection level for the end-to-end SBI message (e.g., no protection, integrity protection only, integrity and confidentiality).

The RAN node 804 may locate the UCF 804 (via the NRF) holding the WTRU context using the UCF ID. The RAN node 804 may request the UCF for authorization verification for the session selection parameters for the WTRU identified by the WTRU temporary ID (814). For example, the UCF 806 may check, based on the stored subscription data, that the WTRU 802 may access the given data network or network slice.

The RAN node 804 may discover and select an appropriate SMF 808 using NRF based on the service selection parameters. The SMF 808 may have registered prior with NRF as being capable of providing service for the service selection parameters. Prior to proceeding with SMF interaction, the RAN node 804 may check with an access control function (e.g., Network Slice Access Control Function (NSCAF) as to whether the new session is allowed to use a given network resource (e.g., a network slice) or if a limit set by the operator is already met. The RAN node 804 may send to the SMF 808 a PDU Session Establishment request message (816), which may include the UCF ID, WTRU temporary ID, the SBI message #1 with protection indication (as described above with respect to 812) and RAN node endpoint information (e.g., AN tunnel information) allocated/assigned for the PDU Session.

The SMF 808 may request (818), from the UCF 806, security processing (e.g., decrypt, integrity check if any) of the SBI message #1 providing the WTRU temporary ID. The SMF 808 may receive from the UCF 806 a cleartext SBI message (if SBI message #1 was encrypted), a PDU Session ID and SM subscription data (if available). The SMF 808 may retrieve SM subscription data from UDM if not provided by UCF 806.

The SMF 808 may process the SBI message for PDU Session establishment based on subscription data and generate an SBI message #2. The SBI message #2 may also be referred to herein as a PDU Session Establishment Accept message. The SMF 808 may configure (820, 824) the UPF 810 for user plane communications using the RAN node endpoint information. If the small data container is present (in step 1), the SMF may route user data directly (using a UPF or NEF).

The SMF (826) may request the UCF 806 to update the WTRU context with session context information (e.g., PDU Session ID, DNN, S-NSSAI, 5QI) and SM subscription data (if retrieved in 818). The SMF may request (826) the UCF 806 to protect the SBI message #2 (e.g., encrypted, integrity protected) using the SBI keys described above if the SBI message #1 was received with protection.

The SMF 808 may send, to the RAN node 804, a message (830) including configuration information (including UPF endpoint information) to establish the user plane resources and the SBI message #2. If the small data container is present (in 812) and the SMF 808 is configured to handle UPF logic, the SMF 808 may provide an endpoint address matching the existing SBI transport, that the RAN node 804 may use to forward the small data from the WTRU 802. The RAN node 804 may send, to the WTRU 802 an RRC message (832) including an indication of the SBI message, a session management service indication, and the SBI message #2.

For a PDU session modification, the PDU session establishment procedure as illustrated in FIG. 8 may be used but with some differences. Similarly, the SBI message #1 may be a PDU session modification request, and the SBI message #2 may be a PDU session modification response. At 812, the WTRU 804 may include a PDU Session ID as part of the session selection parameters (e.g., instead of DNN, S-NSSAI). At 814, the RAN node 804 may check with the UCF 807 that there is an existing session identified by the given PDU Session ID. At 816, the RAN node 804 may send a request to modify the PDU session. At step 818, the SMF 808 may request modification of CN tunnel endpoint from the UPF 810. The SMF 808 may send, to the RAN node 804, a message including configuration information (including UPF endpoint information) to modify the user plane resources and the SBI message #2. The RAN Node 804 may send a response to provide updated AN tunnel information, which the SMF 808 may update the UPF 810 with.

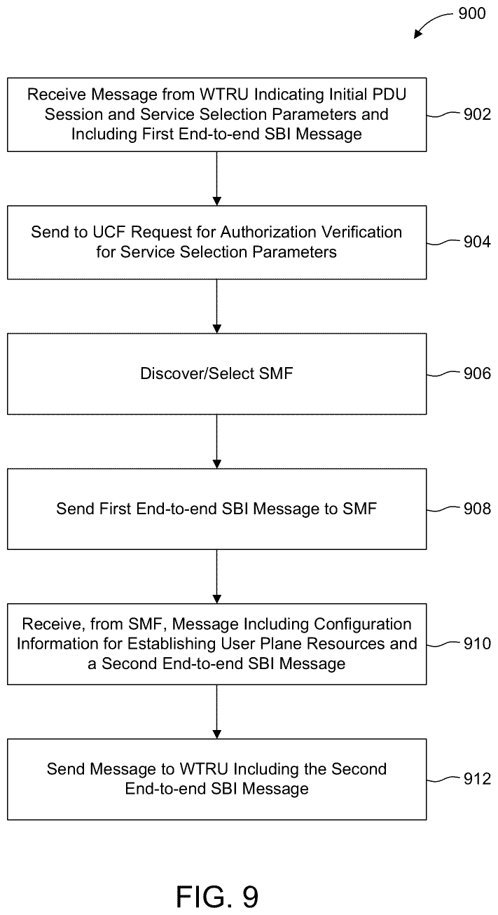

FIG. 9 is a flow diagram 900 of an example method of PDU session establishment implemented in a base station in a distributed control plane architecture. In the example illustrated in FIG. 9, the base station receives a message from a WTRU (902). The message may be an AS message and may include an indication of an initial session, a UCF ID, a WTRU temporary ID, service selection parameters, such as DNN or S-NSSAI, and/or a first end-to-end secure SBI message. In the example illustrated in FIG. 9, the first end-to-end secure SBI message is a PDU session establishment request message.

The base station may send a request (904), to the UCF, to authorize verification for the service selection parameters for the WTRU (identified by the WTRU temporary ID). The UCF may be identified in the request by a UCF ID. The base station may discover and/or select an appropriate SMF (906), for example using NRF and based on the service selection parameters. The base station may send, to the SMF, the first end-to-end secure SBI message (908). The base station may also send, along with the first end-to-end SBI message, the UCF ID, the WTRU temporary ID and base station (e.g., iNB) endpoint information for the PDU session.

The base station may receive, from the SMF, a message (910). The message may include, for example, configuration information (e.g., UPF endpoint) to establish the user plane resource and a second end-to-end secure SBI message. The second end-to-end SBI message may be a PDU session establishment accept message. The base station may send, to the WTRU, a message including the second end-to-end secure SBI message (912). The message may be an AS message.

The transfer of small data or small message service (SMS) over the control plane may be done using a dedicated service (e.g., small_data_mgt_service, short_message_mgt_service). Such service or services may be provided by an SMF as described above or by different functions, such as a new NF Small Data Function (SDF) or an existing NF (e.g., NEF, SMS function (SMSF)). For example, a WTRU may send and receive small data (e.g., IP, unstructured, non-IP data) directly to and from a NEF without the need to allocate user plane resources (in UPF/RAN). Similarly, the WTRU may send and receive SMS directly to and from an SMSF.

FIG. 10 is a block diagram 1000 of the control plane stack between the WTRU 1004 and the CN 1006 with the RAN node acting as the SBI gateway. The End-to-End SBI (or distributed NAS) layer 1002 in the WTRU 1004 may be responsible for the construction and processing of end-to-end SBI messages in the SBI format (e.g., JavaScript Object Notation (JSON)). An end-to-end SBI message from the WTRU 1004 may be transmitted inside RRC messages towards the RAN node. The end-to-end SBI message may then be encapsulated (e.g., in a container) in an SBI message when transferred between NFs (e.g., from the RAN node to the SMF) within the nCN. An end-to-end SBI message to the WTRU 1004 may follow the reverse path.

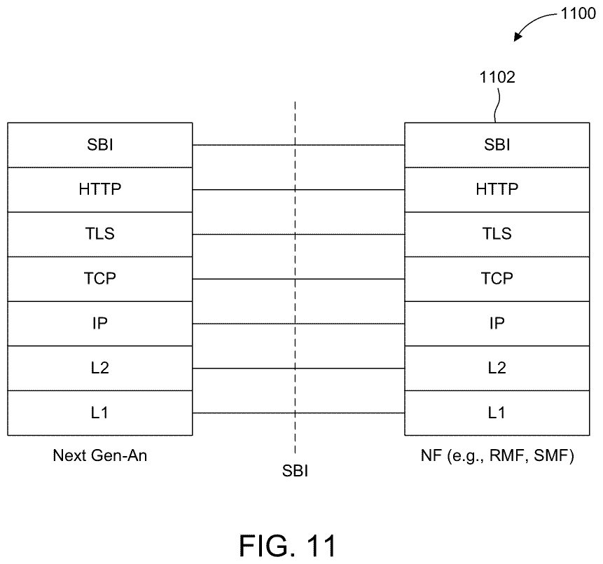

FIG. 11 is a diagram showing an example next generation control plane protocol stack (e.g., RRC or PDCP) between the RAN and the CN with an SBI capable RAN. The SBI interface 1102 in the nCN may use a Quick UDP Internet Connection (QUIC) over UDP instead of TLS over TCP (not shown in FIG. 11).

For backward compatibility purposes, an (Next Generation WTRU) nWTRU (e.g., WTRU with SBI or distributed NAS capability) may detect, from RAN SIB information, that SBI interface capabilities are supported by the RAN node. Otherwise, the nWTRU may use or fall back to NAS over RRC with a legacy base station, such as a gNB. The nWTRU may implement a dual stack to allow communicating using either NR or a next generation air interface. A gNB upgraded to connect to the nCN (e.g., ng-gNB) may provide the 5G new radio (NR) air interface with support for SBI over RRC transport as described above to be able to connect nWTRUs to the nCN. Such ng-gNB can connect 5G WTRUs to the 5GC by supporting N2 along with the SBI interface. The ng-gNB may determine to route the initial message from a WTRU to the nCN if the WTRU includes an indication of SBI message (as described above) or else to the 5GC. This may provide operators and handset manufacturers with a possible transition path towards the next generation network, while leverage existing 5G RAN deployment and coverage (e.g., by means of RAN node software upgrade).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A base station comprising:
a transceiver; and
a processor,
wherein the transceiver and the processor are configured to transmit information in a system information block (SIB), wherein the information comprises an indication that the base station is configured to operate as a service based interface (SBI) gateway between one or more wireless transmit/receive units (WTRUs) and an SBI capable core network,
wherein the transceiver and the processor are further configured to receive, from a WTRU of the one or more WTRUs, a first radio resource control (RRC) message, wherein the first RRC message comprises an end-to-end SBI registration request message for the SBI capable core network, and
wherein the transceiver and the processor are further configured to send a first SBI message, to an authentication and authorization function (AAF) of the SBI capable core network, wherein the first SBI message comprises the end-to-end SBI registration request message and an indication of a type of authentication and authorization requested.

2. The base station of claim 1, wherein the transceiver and the processor are further configured to receive a second SBI message, from the AAF, wherein the second SBI message comprises an end-to-end SBI authentication request message that comprises one of a request for an identity of the WTRU to be authenticated or a challenge to authentication of the WTRU.

3. The base station of claim 2, wherein the transceiver and the processor are further configured to:
receive, from the AAF, a third SBI message, wherein the third SBI message comprises an end-to-end security mode command SBI message intended for the WTRU, wherein the end-to-end security mode command SBI message is protected using a first security key derived from an SBI access key that was derived by the WTRU and the AAF during authentication, and
send, to the WTRU, the end-to-end security mode command SBI message.

4. The base station of claim 3, wherein the processor and the transceiver are further configured to:
receive a fourth SBI message from the WTRU, wherein the fourth SBI message comprises an end-to-end security mode command complete SBI message, wherein the end-to-end security mode command complete SBI message is confidentiality protected using a second security key derived from the SBI access key and is integrity protected using the first security key, and
send, to the AAF, the end-to-end security mode command complete SBI message.

5. The base station of claim 1, wherein the transceiver and the processor are further configured to receive, from the AAF, a fifth SBI message, wherein the fifth SBI message comprises an indication of successful authentication of the WTRU, a WTRU identifier (ID) for the WTRU, and a security context comprising an indication of the first security key, the second security key, and the SBI access key.

6. The base station of claim 5, wherein the transceiver and the processor are further configured to:
send a request, to a WTRU context management function (UCF), to create a new WTRU context for the WTRU,
store the first security key, the second security key, and the SBI access key in the WTRU context, and
receive, from the UCF, a temporary ID for the WTRU.

7. The base station of claim 5, wherein the transceiver and the processor are further configured to:
send a registration request message to a registration and mobility management function (RMF), wherein the registration request message comprises the end-to-end SBI registration request message, and
receive, from the RMF, a registration response message, wherein the registration response message comprises an end-to-end SBI registration accept message that is protected by the UCF.

8. The base station of claim 7, wherein the transceiver and the processor are further configured to:
send a request, to the UCF, for an access stratum (AS) session key,
register, with the UCF, as a last known serving base station,
subscribe, to the UCF, for WTRU-related notifications,
perform security establishment with the WTRU to secure radio resource control (RRC) transmissions, and
send, to the WTRU, a second RRC message, wherein the second RRC message comprises the end-to-end SBI registration accept message.

9. A wireless transmit/receive unit (WTRU) comprising:
a transceiver; and
a processor,
wherein the transceiver and the processor are configured to decode a system information block (SIB), wherein the SIB comprises an indication that a base station is configured to operate as a service based interface (SBI) gateway between one or more wireless transmit/receive units (WTRUs) and an SBI capable core network, and
wherein the transceiver and the processor are further configured to transmit, to the base station, a first radio resource control (RRC) message, wherein the first RRC message comprises an end-to-end SBI registration request message for the SBI capable core network.

10. The WTRU of claim 9, wherein the transceiver and the processor are further configured to receive, from the base station, an end-to-end security mode command SBI message, wherein the end-to-end security mode command SBI message is protected using a first security key derived from an SBI access key that was derived by the WTRU and an authentication and authorization service function (AAF) during authentication.

11. The WTRU of claim 10, wherein the processor and the transceiver are further configured to:
receive a second RRC message from the base station, wherein the second RRC message comprises an end-to-end security mode command SBI message, wherein the end-to-end security mode command SBI message is confidentiality protected using a second security key derived from the SBI access key and is integrity protected using the first security key, and
send, to the base station, a third RRC message, wherein the third RRC message comprises an end-to-end security mode complete SBI message.

12. The WTRU of claim 9, wherein the transceiver and the processor are further configured to receive, from the base station, a fourth RRC message, wherein the fourth RRC message comprises an end-to-end SBI registration accept message.

13. A method, implemented in a base station, the method comprising:
transmitting information in a system information block (SIB), wherein the information comprises an indication that the base station is configured to operate as a service based interface (SBI) gateway between one or more wireless transmit/receive units (WTRUs) and an SBI capable core network;
receiving, from a WTRU of the one or more WTRUs, a first radio resource control (RRC) message, wherein the first RRC message comprises an end-to-end SBI registration request message for the SBI capable core network; and
sending a first SBI message, to an authentication and authorization function (AAF) of the SBI capable core network, wherein the first SBI message comprises the end-to-end SBI registration request message and an indication of a type of authentication and authorization requested.

14. The method of claim 13, further comprising receiving a second SBI message, from the AAF, wherein the second SBI message comprises an end-to-end SBI authentication request message that comprises one of a request for an identity of the WTRU to be authenticated or a challenge to authentication of the WTRU.

15. The method of claim 14, further comprising:
receiving, from the AAF, a third SBI message, wherein the third SBI message comprises an end-to-end security mode command SBI message intended for the WTRU, wherein the end-to-end security mode command SBI message is protected using a first security key derived from an SBI access key that was derived by the WTRU and the AAF during authentication; and
sending, to the WTRU, the end-to-end security mode command SBI message.

16. The method of claim 15, further comprising:
receiving a fourth SBI message from the WTRU, wherein the fourth SBI message comprises an end-to-end security mode command complete SBI message, wherein the end-to-end security mode command complete SBI message is confidentiality protected using a second security key derived from the SBI access key and is integrity protected using the first security key; and
sending, to the WTRU, the end-to-end security mode command complete SBI message.

17. The method of claim 13, further comprising receiving, from the AAF, a fifth SBI message, wherein the fifth SBI message comprises an indication of successful authentication of the WTRU, a WTRU identifier (ID) for the WTRU, and a security context comprising an indication of the first security key, the second security key, and the SBI access key.

18. The method of claim 17, further comprising:
sending a request, to a WTRU context management function (UCF), to create a new WTRU context for the WTRU,
store the first security key, the second security key, and the SBI access key in the WTRU context, and
receive, from the UCF, a temporary ID for the WTRU.

19. The method of claim 17, further comprising:
sending a registration request message to a registration and mobility management function (RMF), wherein the registration request message comprises the end-to-end SBI registration request message; and
receiving, from the RMF, a registration response message, wherein the registration response message comprises an end-to-end SBI registration accept message that is protected by the UCF.

20. The method of claim 17, further comprising:
sending a request, to the UCF, for an access stratum (AS) session key;
registering, with the UCF, as a last known serving base station;
subscribing, to the UCF, for WTRU-related notifications;
performing security establishment with the WTRU to secure radio resource control (RRC) transmissions; and
sending, to the WTRU, a second RRC message, wherein the second RRC message comprises the end-to-end SBI registration accept message.
